(19) United States
(12) Patent Application Publication
(10) Pub. No.: US 2009/0202330 A1
(43) Pub. Date: Aug. 13, 2009

(54) Guide System for Loading Trailers with Cargo

(76) Inventor: Thomas Hamather, Orlando, FL (US)

Correspondence Address: McKinney Law, LLC, 121 S. Orange Ave, Suite 1500, Orlando, FL, 32801, US

(21) Appl. No.: 12/369,292

(22) Filed: Feb. 11, 2009

Related U.S. Application Data
(60) Provisional application No. 61/027,506, filed on Feb. 11, 2008.

(51) Int. Cl. B65G 47/24; F16H 47/00

(52) U.S. Cl. 414/754; 74/730.1; 74/732.1

(57) ABSTRACT

A guide system for loading trailers with cargo is disclosed. In a particular embodiment, the system includes first and second tubular sleeves adapted to removably slide over cylindrical bollards, wherein the tubular sleeves are configured to rotate about a vertical axis of the cylindrical bollards. The system also includes first and second arms secured to the respective tubular sleeves, wherein the arms are adapted to sweep over a horizontal surface of a loading dock when the tubular sleeves are rotated. In addition, the system includes first and second pistons, wherein a first end of each piston is secured to a rear portion of the respective arm and the arm swings to a desired position in response to the respective piston. A slidable pin of each arm is configured to engage receptacles mounted in a horizontal surface of a loading dock when the arms are in a closed position.

### I. CROSS REFERENCE TO RELATED APPLICATIONS

This application claims the benefit of U.S. Provisional Application No. 61/027,506 filed Feb. 11, 2008. The disclosure of the provisional application is incorporated herein by reference.

### II. FIELD

The present disclosure relates generally to cargo loading systems, and more specifically to providing a system used for loading pallets of cargo into a trailer from a loading dock without causing damage to the cargo or trailer.

### III. DESCRIPTION OF RELATED ART

The current practice to load trailers with cargo includes having the semi trailer backed up to the raised platform of the loading dock. The loading dock is then at the height of the floor of the semi trailer so that pallets of goods are ready to be loaded into the trailer from the warehouse. A forklift picks up each pallet from the loading dock and enters the semi trailer a number of times until all cargo is loaded. Due to the narrow constraints of a semi trailer, often times the forklift operator inadvertently impacts the sides of the entrance to the trailer or the sides of the loading dock so that goods being loaded are significantly damaged. Accordingly, there is a need for an improved system for loading cargo into trailers that reduces the amount of damage during the loading process.

There have been attempts to improve the loading process such as Patent Publication No. 2005/0053451 to Gagnon, which includes a loading system having a pair of guiding gates. The gates are sized to extend their outer ends slightly beyond the dock opening when in an open position so that their tips rest against the inner walls of a semi trailer. Hydraulic rams are used to control the pivotal displacement of the gates. A shortcoming of Gagnon is the orientation of the hydraulic rams substantially parallel to the gates in a deployed position so that the guides have less independent strength to absorb forces as the pallets are loaded.

Another example is U.S. Pat. No. 3,186,566 to Spinanger, which includes a pair of vertical guides pivotally mounted on pipes anchored in the warehouse floor. The guides are positioned to funnel cargo into a van during the loading operation. Similar to Gagnon, a shortcoming of Spinanger is that the guides have little independent strength and rely on the inside wall of the semi trailer for support. Accordingly, what is needed is a guide system that has increased strength.

Another need exists in the art for an improved guide system that is removable so that it can be used at any desired loading location.

Notwithstanding the existence of prior art loading devices, there is a need for an improved guide system for loading trailers with cargo.

It is, therefore, to the effective resolution of the aforementioned problems and shortcomings of the prior art that the present invention is directed.

However, in view of the prior art at the time the present invention was made, it was not obvious to those of ordinary skill in the pertinent art how the identified needs could be fulfilled.

### IV. SUMMARY

In a particular embodiment, a guide system for loading trailers with cargo is disclosed. A first tubular sleeve is adapted to removably slide over a first cylindrical bollard, wherein the first tubular sleeve is onfigured to rotate about a vertical axis of the first cylindrical bollard. A first arm is secured to the first tubular sleeve, wherein the first arm is adapted to sweep over a horizontal surface of a loading dock when the first tubular sleeve is rotated. A first end of a first piston is secured to a rear portion of the first arm and the first arm swings to a desired position in response to the first piston. A first base plate is provided to maintain a second end of the first piston stationary when the first end of the first piston is extended and retracted. A solenoid is connected to a pressurized main air supply line and a first piston first air supply line and a first piston second air supply line are connected to the solenoid, wherein the solenoid pressurizes either the first piston first air supply line or the first piston second air supply line to retract or extend the first piston. The first piston also includes a first port in communication with the first piston first air supply line and a second port in communication with the first piston second air supply line. In addition, the first piston is positioned to form an acute angle between the first piston and the first arm when the first arm is in an open position. A control box is in electrical communication with the solenoid and is used to operate the guide system. The shape of the first arm is generally rectangular with an obtuse angle bend at a connection point between the first arm and the first tubular sleeve.

The system may also include a second tubular sleeve adapted to removably slide over a second cylindrical bollard, wherein the second tubular sleeve configured to rotate about a vertical axis of the second cylindrical bollard. A second arm is secured to the second tubular sleeve, wherein the second arm is adapted to sweep over the horizontal surface of the loading dock when the second tubular sleeve is rotated. A first end of a second piston may be secured to a rear portion of the second arm and the second arm swings to a desired position in response to the second piston. The second piston further includes a first port that is in communication with the first piston first air supply line and a second port in communication with the first piston second air supply line so that the first and second pistons may retract or extend together.

One particular advantage provided by embodiments of the guide system for loading trailers with cargo is that the arms act as guides and force the pallets to stay aligned as the pallets are being pushed into the semi trailer. The piston secured to each arm provides significant resistance to pallets that may become misaligned when they are being loaded. The piston is used to retract and deploy the arms with significant force. Without the arms, the pallets would not stay aligned as they are pushed and may impact the sides of the loading dock and/or the sides of the semi trailer as the pallets are being loaded.

Another particular advantage provided by embodiments of the guide system for loading trailers with cargo is the increases in efficiency of loading cargo into a semi trailer and at the same time reduces the amount of damaged cargo. Further, the arms can be easily removed from the bollards by sliding them up and off so that they can be moved to another loading dock where needed. In the preferred embodiment, the pistons are pneumatic pistons, however, the pistons may be hydraulic, electrically driven, manually operated, or any combination thereof.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a diagram of a perspective view of a loading dock showing a particular embodiment of a guide system secured to bollards on either side of a trailer;

FIG. 2 is a diagram of a top view showing the particular embodiment of a guide system of FIG. 1 in an opened position;

FIG. 3 is a diagram of a top view showing the particular embodiment of a guide system of FIGS. 1 and 2 in a closed position;

FIG. 4 is a diagram of a perspective view of a particular embodiment of the guide system in an opened position;

FIG. 5 is a diagram of a perspective view of the particular embodiment of the guide system of FIGS. 1-4;

FIG. 6 a diagram of a top view of the particular embodiment of the guide system of FIGS. 1-3 showing slidable pins to maintain the guide system in a closed position; and

FIG. 7 is a diagram of a perspective view of the particular embodiment of the guide system of FIG. 6.

### VI. DETAILED DESCRIPTION

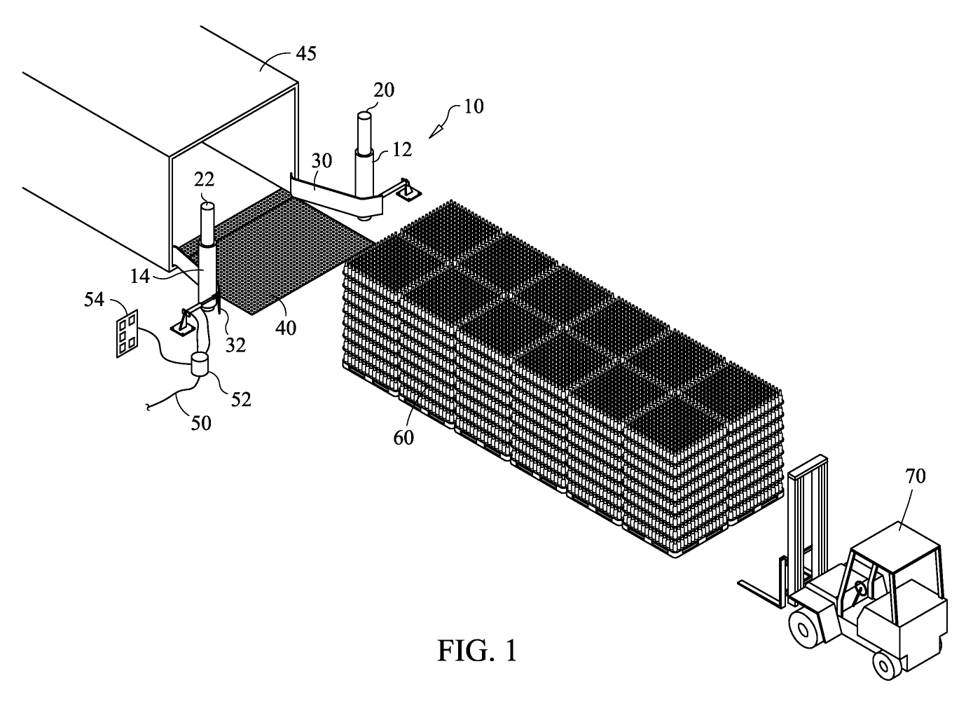

Referring to FIG. 1, a particular illustrative embodiment of a guide system for loading trailers with cargo is disclosed and generally designated 10. The guide system includes a pair of guides 30, 32. Each guide 30, 32 includes a tubular sleeve 12, 14 that is adapted to slide over a cylindrical bollard 20, 22 and an arm 30, 32 that is generally rectangular in shape and is orientated to sweep over the horizontal surface of a loading dock 40. A first guide 30 of the pair of guides 30, 32 is located on a first side of the loading dock 40 and is disposed to pivot about a vertical axis from a closed position to an open position in a clockwise motion. A second guide 32 is located on a second side of loading dock 40 and is disposed to pivot about a vertical axis from a closed position to an open position in an opposing counter-clockwise motion to the first guide arm 30. Each guide arm 30, 32 rotates about a respective bollard 20, 22 to an open position until the tip of a first end of each guide arm 30, 32 is adjacent to the inside wall of a trailer 45 to provide a tapered transition between bollards 20, 22 and the entrance to trailer 45.

A first end of each of a pair of pneumatic pistons 112, 114 is secured to the second end of each respective guide arm 30, 32. A second end of each pneumatic piston 112, 114 is secured to a base plate and disposed so that when the first end of each piston is extended and retracted, the second end of piston remains stationary causing the respective guide arms 30, 32 to rotate about the bollards 20, 22. A pressurized main air supply line 50 is connected to a solenoid 52. Exiting from the solenoid 52 is a first piston first air supply line 72 and a first piston second air supply line 74. The solenoid 52 pressurizes either the first piston first air supply line 72 or the second air supply line 74. The first piston first air supply line 72 is in communication with the first port of the first and second pneumatic pistons 112, 114 and the second air supply line is in communication with the second port of the first and second pneumatic pistons 112, 114 so that the pair of pistons operate in concert. Control box 54 is in electrical communication with solenoid 52 so that a user can operate guide system 10 to move guide arms 30, 32 from the open and closed positions.

In operation, pallets 60 are aligned to be pushed into trailer 45 using forklift 70. As pallets 60 loaded with product are pushed by forklift 70 and slide over the floor into trailer 45, guide arms 30, 32 prevent pallets 60 from contacting bollards 20, 22 or the sides of trailer 45, thereby preventing damage to the product loaded on the pallets 60. Due to the orientation of each piston to the respective guide arm 30, 32, if the pallets 60 do contact guide arms 30, 32, guide arms provide a mechanical advantage and additional strength to maintain the alignment of pallets 60 as they are being loaded into trailer 45.

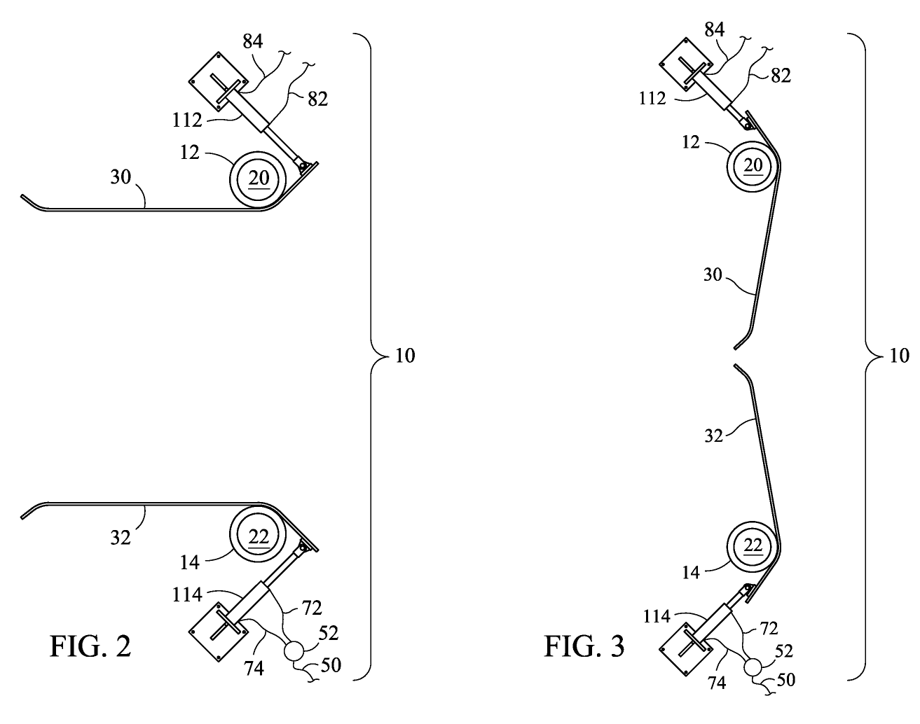

Referring now to FIG. 2, guide system 10 is shown in an open position. Guide arms 30, 32 are rotated so that they are parallel and aligned with the sides of a trailer (not shown). A first end of pistons 112, 114 are secured to the second ends of guide arms 30, 32. As the pistons are retracted, guide arms 30, 32 are rotated from the open position to a closed position. Tubular members 12, 14 provide the pivot point for the guide arms 30, 32 as they are being rotated about bollards 20, 22. Main air supply line 50 enters solenoid 52 and first piston first air supply line 72 and first piston second air supply line 74 exit solenoid 52. The first piston first air supply line 72 of the first pneumatic piston is connected to the first port of piston 114 and also feeds the first port of second piston 112. Similarly, first piston second air supply line 74 of the first pneumatic piston is connected to the second port of the first piston 114 and also feeds the second port of second piston 112.

FIG. 3 illustrates the guide system 10 in a closed position. The guide arms 30, 32 are rotated so that they are aligned and provide a barrier to the loading dock 40. This is a safety feature that prevents, for example, a forklift from accidentally driving off the loading dock 40 when the trailer 45 is not in position.

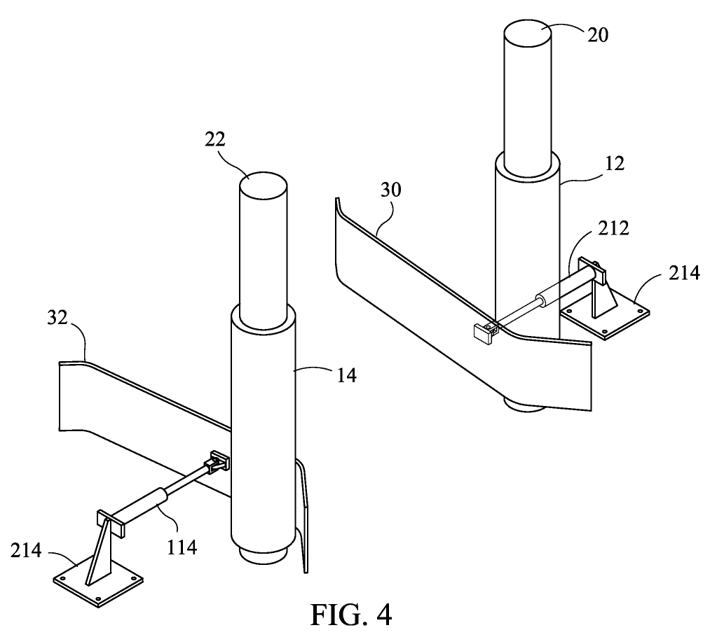

Referring now to FIG. 4, a perspective view of an alternative embodiment of the orientation of base 214 that provides the anchor for pistons 112, 114. For example, the attachment locations of the pistons 114, 112 are on the opposite side of the bollards 20, 22 shown in FIGS. 1-3. Guide arms 32, 30 are shown rotated to the open position.

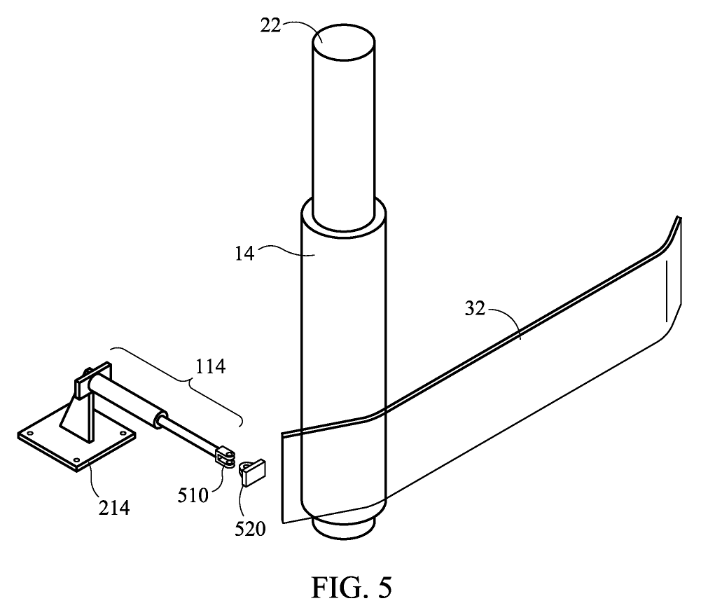

FIG. 5 illustrates the elements that comprise the mechanism for guide system 10. Although, only one guide arm 32 and associated components are shown in FIG. 5, a similar arrangement and components comprise the second arm. Piston 114 includes a U-shaped connector 510 at the first end of piston 114 adapted to removably receive a flat connector 520 attached to the second end of arm 32. The flat connector 520 slides into U-shaped connector 510 so that apertures of both connectors are aligned. Accordingly, a connection pin may be inserted through the apertures thereby coupling guide arm 32 to piston 114. Thus, guide arm 32 is easily removed and relocated by pulling the pin securing connectors 510, 520 together and sliding tubular sleeve 14 upwards and off bollard 22. Bolts securing base 214 are removed so that base 214 and attached piston 114 can be relocated.

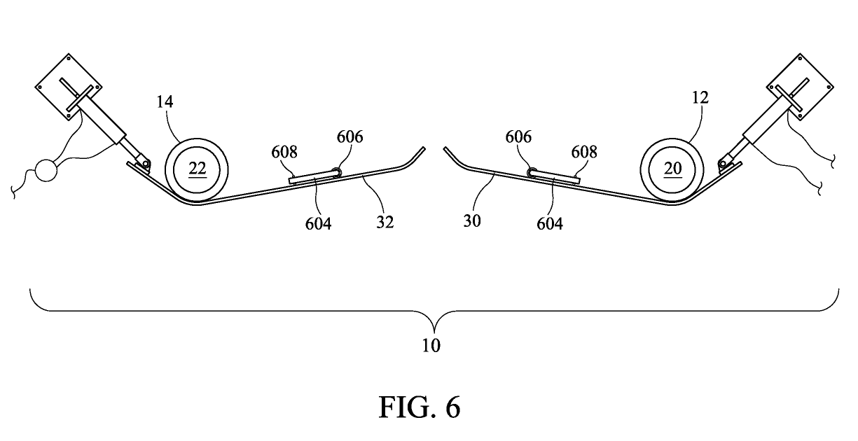

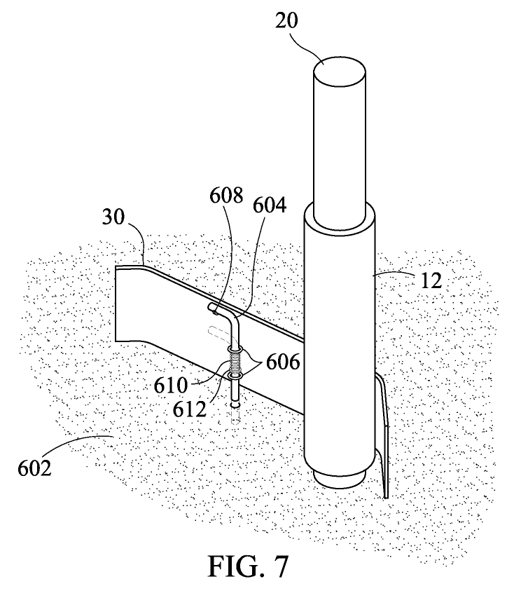

A slidable pin 604 may be used to lock the arms 30, 32 in a closed position as illustrated in FIG. 6. In operation, the pin 604 is pushed down to engage a receptacle mounted in the floor 602 of the loading dock. When the pin 604 is inserted into the receptacle, the arms 30, 32 cannot be moved. Referring now to FIG. 7, the pin 604 is secured to a rear portion of the arm 30 using a pair of guides 606. A locking collar 612 may be used to provide the desired tension of the spring 610. A catch 608 may be used to maintain the slidable pin 604 in an up position when not needed. The slidable pin 604 is grasped and turned to free the pin 604 from the catch 608. Once the slidable pin 604 is free, the pin 604 may be pushed to engage the receptacle in the floor 602 when the arms 30, 32 are in the closed position. Thus, the arms 30, 32 may act as a gate to prevent inadvertent passage by a forklift or other vehicle off the end of the loading dock. Alternatively, each arm 30, 32 may be locked independently.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.52(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A guide system for loading trailers with cargo, the system comprising:
a first tubular sleeve adapted to removably slide over a first cylindrical bollard, wherein the first tubular sleeve configured to rotate about a vertical axis of the first cylindrical bollard;
a first arm secured to the first tubular sleeve, wherein the first arm is adapted to sweep over a horizontal surface of a loading dock when the first tubular sleeve is rotated; and
a first piston, wherein a first end of the first piston is secured to a rear portion of the first arm and the first arm swings to a desired position in response to the first piston.

2. The guide system of claim 1, further comprising a first base plate to maintain a second end of the first piston stationary when the first end of the first piston is extended and retracted.

3. The guide system of claim 2, further comprising a pressurized main air supply line.

4. The guide system of claim 3, further comprising a solenoid connected to the main air supply line.

5. The guide system of claim 4, further comprising a first piston first air supply line and a first piston second air supply line connected to the solenoid, wherein the solenoid pressurizes either the first piston first air supply line or the first piston second air supply line.

6. The guide system of claim 5, wherein the first piston further comprising:
a first port in communication with the first piston first air supply line; and
a second port in communication with the first piston second air supply line.

7. The guide system of claim 6, further comprising a control box in electrical communication with the solenoid to operate the guide system.

8. The guide system of claim 7, wherein the first arm further comprising an obtuse angle bend at a connection point between the first arm and the first tubular sleeve.

9. The guide system of claim 8, wherein the first piston is positioned to form an acute angle between the first piston and the first arm when the first arm is in an open position.

10. The guide system of claim 9, wherein the first arm further comprising a first slidable pin mounted vertically on the rear portion of the first arm, the first slidable pin configured to engage a first receptacle mounted in the horizontal surface of the loading dock when the first arm is in a closed position and the first slidable pin is in a down position.

11. The guide system of claim 10, wherein the first piston further comprising a first U-shaped connector at the first end of the first piston and adapted to removably receive a first flat connector attached to the second end of the first arm, the first flat connector configured to slide into the first U-shaped connector and align apertures of the first U-shaped connector and the first flat connector.

12. The guide system of claim 11, further comprising a first connection pin for insertion through the apertures to removably couple the first arm and the first piston.

13. The guide system of claim 12, further comprising:
a second tubular sleeve adapted to removably slide over a second cylindrical bollard, wherein the second tubular sleeve configured to rotate about a vertical axis of the second cylindrical bollard;
a second arm secured to the second tubular sleeve, wherein the second arm is adapted to sweep over the horizontal surface of the loading dock when the second tubular sleeve is rotated; and
a second piston, wherein a first end of the second piston is secured to a rear portion of the second arm and the second arm swings to a desired position in response to the second piston.

14. The guide system of claim 13, further comprising a second base plate to maintain a second end of the second piston stationary when the first end of the second piston is extended and retracted.

15. The guide system of claim 14, wherein the second piston further comprising:
a first port of the second piston in communication with the first piston first air supply line; and
a second port of the second piston in communication with the first piston second air supply line.

16. The guide system of claim 15, wherein the second arm further comprising an obtuse angle bend at a connection point between the second arm and the second tubular sleeve.

17. The guide system of claim 16, wherein the second piston is positioned to form an acute angle between the second piston and the second arm when the second arm is in an open position.

18. The guide system of claim 17, wherein the second arm further comprising a second slidable pin mounted vertically on the rear portion of the second arm, the second slidable pin configured to engage a second receptacle mounted in the horizontal surface of the loading dock when the second arm is in a closed position and the second slidable pin is in a down position.

19. The guide system of claim 18, wherein the second piston further comprising a second U-shaped connector at the first end of the second piston and adapted to removably receive a first flat connector attached to the second end of the first arm, the first flat connector configured to slide into the first U-shaped connector and align apertures of the first U-shaped connector and the first flat connector.

20. The guide system of claim 19, further comprising a second connection pin for insertion through the apertures to removably couple the second arm and the second piston.
